(19) United States
(12) Patent Application Publication
(10) Pub. No.: US 2002/0016742 A1
(43) Pub. Date: Feb. 7, 2002

(54) Retail system with purchase ordering

(76) Inventor: Sergey N. Razumov, Moscow (RU)

Correspondence Address: MCDERMOTT, WILL & EMERY, 600 13th Street, N.W., Washington, DC, 20005-3096, US

(21) Appl. No.: 09/745,420

(22) Filed: Dec. 26, 2000

Related U.S. Application Data
(60) Provisional application No. 60/222,292, filed on Aug. 1, 2000.
(60) Provisional application No. 60/233,664, filed on Sep. 19, 2000.

(51) Int. Cl. G06F 17/60

(52) U.S. Cl. 705/26

(57) ABSTRACT

A novel retail system is provided with purchase ordering facilities that contain samples of items offered for sale. A portable device carried by a customer is provided in the purchase ordering facility for reading indicia on the samples to select required items to be included in a purchase order. A purchase ordering terminal is installed for enabling the customer to order all products available in the retail system including items that are not represented by the samples contained in the purchase ordering facility.

The present application claims priority of U.S. provisional application No. 60/222,292 filed on Aug. 1, 2000 and entitled “RETAIL SYSTEM USING INTERNET PRODUCT ORDERING”, and U.S. provisional application No. 60/233,664 filed on Sep. 19, 2000 and entitled “SHOPPING FACILITY FOR INTERNET-BASED RETAIL SYSTEM”, both applications being incorporated herewith by reference.

### FIELD OF THE INVENTION

The present invention relates to retail systems, and more specifically, to a retail system having mechanisms that enable customers to place a purchase order.

### BACKGROUND OF THE INVENTION

Multiple Web servers have been developed for conducting electronic commerce via the Internet. They enable vendors to advertise and sell various products to be delivered through a carrier or mail. A server computer system may provide an electronic version of a catalog that lists available items. A user may browse through the catalog using a browser and select various items to be purchased. The selection of the various items from the electronic catalog generally imitates a shopping cart. When the user selects an item from the electronic catalog, the server computer system metaphorically adds that item to the user's “shopping cart.”

When the user has completed selecting the items to be purchased, the server computer system prompts the user for information to complete the ordering of the items. This purchase-specific order information may include the purchaser's name, the purchaser's credit card information, and a shipping address for the order. Then, server computer system confirms the order and schedules shipment of the item.

Thus, the user sequentially selects various items from the electronic catalog, then indicates that the selection is complete, and thereafter, submits the purchase-specific order information. Accordingly, the traditional Internet-based system for placing purchase orders requires many interactions between the user and the server carried out via the Internet. As a result, the Internet-based purchase ordering becomes slow and cumbersome.

In addition, many purchase order transactions require the transmission of sensitive user's information over the Internet. However, when the sensitive information is transmitted over the Internet, it can be intercepted and stolen.

Therefore, there exists a long-felt need for a way to alleviate the difficulties of Internet-based purchase ordering. Also, a need exists for a way to avoid the transmission of sensitive user's information over the Internet.

### SUMMARY OF THE INVENTION

The present application provides a novel retail system with a purchase ordering mechanism that addresses problems of Internet-based purchase ordering. The retail system controlled by a control system comprises at least one storage facility for storing goods available for sale in the retail system, multiple purchase ordering facilities for enabling a customer to order a purchase, and multiple purchase obtaining points. Each purchase obtaining point enables the customer to obtain the ordered purchase after a time period sufficient to deliver the ordered purchase from the storage facility to the purchase obtaining point.

In accordance with one aspect of the invention, the purchase ordering facilities provide representations of items offered for sale. Portable devices may be provided in the purchase ordering facility for detecting indicia of these representations to enable customers to select the items to be included in a purchase order.

For example, the purchase ordering facility may contain samples of items offered for sale. A customer may direct the portable device in direction of a sample to read indicia on the sample. Total price of a purchase may be displayed after reading the indicia of each sample. The customer may be enabled to edit the purchase order formed by the portable device.

Also, the purchase ordering facility may contain at least one purchase ordering terminal for enabling a customer to order all products available in the retail system including items that are not represented in the purchase ordering facility. The purchase ordering terminal may read purchase order information from the portable device to enable the customer to continue placing the product order after selecting the items using the portable device.

For example, the purchase ordering terminal may electronically simulate a store containing products available in the retail system, or a game, such as a soccer, hockey or football. Also, the purchase ordering terminal may simulate operations of an e-commerce Internet site.

The purchase ordering facility may contain at least one output device for producing an output representing the purchase order. For example, the output device may be a printer for providing a purchase order printout. Alternatively, an electronic receipt may be generated.

The output device may be provided with indicia readable by the portable device. The purchase order may be automatically transferred from the portable device to a central station when the portable device reads the indicia of the output device. Also, the output representing the purchase order formed by the portable device may be automatically produced when the portable device reads the indicia of the output device. If a purchase ordering facility is combined with a purchase check-out facility, the output representing the purchase order may be used to control a passing device that allows the customer to leave the retail facility. This measure is useful to prevent stealing of ordered products.

In accordance with another aspect of the invention, a purchase ordered at a purchase ordering facility may be received at a retail facility remote with respect to the purchase ordering facility. The portable device may enable a customer to select the retail facility, to which the ordered purchase should be delivered.

In accordance with a further aspect of the invention, while the portable device enables a customer to form a purchase order based on representations of a limited number of items offered for sale, the purchase ordering terminal enables the customer to order all products available in the retail system.

Still other objects and advantages of the present invention will become readily apparent from the following detailed description, simply by way of illustration of the best mode contemplated of carrying out the invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 illustrates a retail system of the present invention.

FIG. 2 illustrates an exemplary embodiment of a retail facility in the retail system of the present invention.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and entities are shown in block diagram form in order to avoid unnecessarily obscuring the present invention.

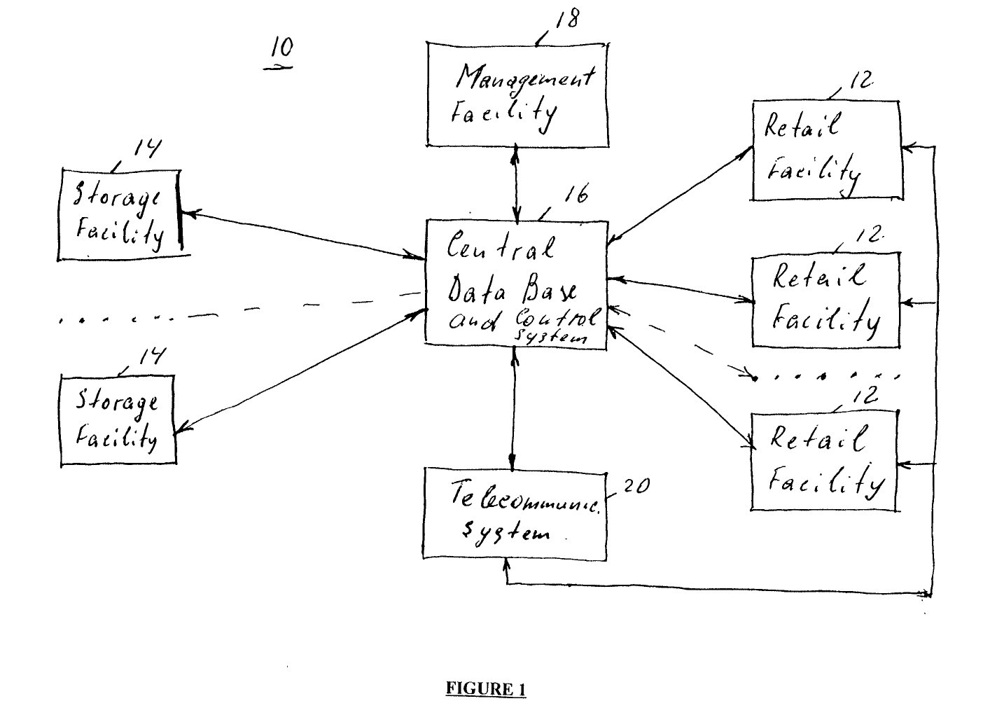

As schematically illustrated in FIG. 1, a retail system 10 of the present invention may comprise a plurality of retail facilities 12 for enabling customers to order and/or receive purchases, a plurality of storage facilities 14, a central data base and control system 16, a management facility 18, and a telecommunications system 20, such as an Internet-based communications network. For example, the retail system 10 of the present invention may sell such items as food products, consumer goods, video/audio products, etc. A delivery system may be provided to enable delivery of goods to the storage facilities 14, and from the storage facilities 14 to the retail facilities 12.

Each retail facility 12 may be a purchase ordering facility that enables a customer to place an order for a purchase, or a purchase check-out facility that provides the check-out of the purchase ordered by the customer. Alternatively, the purchase ordering facility may be combined with the check-out facility.

In accordance with the present invention, a location for placing an order for a purchase is independent from the location where the ordered purchase may be checked out and picked up. While a customer may place an order and receive the ordered purchase at the same retail facility 12, the customer is enabled to order a purchase at one retail facility 12, and receive the ordered purchase at another retail facility 12. For example, a customer may place a purchase order at the retail facility 12 located near the customer's place of business, and receive the ordered purchase at the retail facility 12 located near the customer's residence.

The storage facilities 14 are provided for storing goods available for sale via the retail facilities 12. Also, the storage facilities 14 may provide collecting of items to prepare the ordered purchases to be delivered to the respective retail facility 12. For instance, one storage facility 14 may be provided in a particular area to supply the retail facilities 12 arranged in that area with the ordered purchases. A time interval between placing an order for a purchase and picking up the ordered purchase should be sufficient to deliver the purchase from the corresponding storage facility 14 to the retail facility 12.

The central data base and control system 16 performs collection, storage and processing of data required to support operations of the retail system 10. Also, the central data base and control system 16 supports interactions between various elements of the retail system 10. For example, as discussed in more detail below, the central data base and control system 16 may provide the storage facilities 14 with purchase order information in response to purchase order requests from the retail facilities 12.

The management facility 18 performs management and administrative functions required to support operations of the retail system 10. For example, the management facility 18 may monitor retail system operations to detect and correct errors and malfunctions. Also, the management facility 18 may be responsible for maintaining adequate amount of goods at the storage facilities 12, collecting and analyzing sales information, marketing, and establishing prices.

The telecommunications system 20 enables customers to place purchase orders from locations remote with respect to the retail system facilities. In particular, the retail facilities 12 of the present invention may provide the checkout of purchases ordered via the Internet or a telephone system. The telecommunications system 20 may support the customer's access to the central data base and control system 16 to receive information on product availability and prices.

To facilitate the ordering process, the customer may be provided with a data storage device, such as a CD-ROM or DVD device, which contains information on items available in the retail system 10. The telecommunications system 20 may connect the customer's data storage device to the central data base and control system 16 to update the information stored by the data storage device.

The telecommunications system 20 transmits information on a purchase order placed by a customer to the central data base and control system 16 for arranging purchase delivery from the respective storage facility 14 to the retail facility 12 selected by the customer.

In an alternative embodiment of the invention, the telecommunications system 20 supports placing an order via a telephone system. In this case, a customer can place a telephone call to an operator to order a purchase composed of items selected based on the information provided by the operator or using a list of available items. The present invention enables the customer that made a telephone purchase order to receive the ordered purchase at any retail facility 12 selected by the customer.

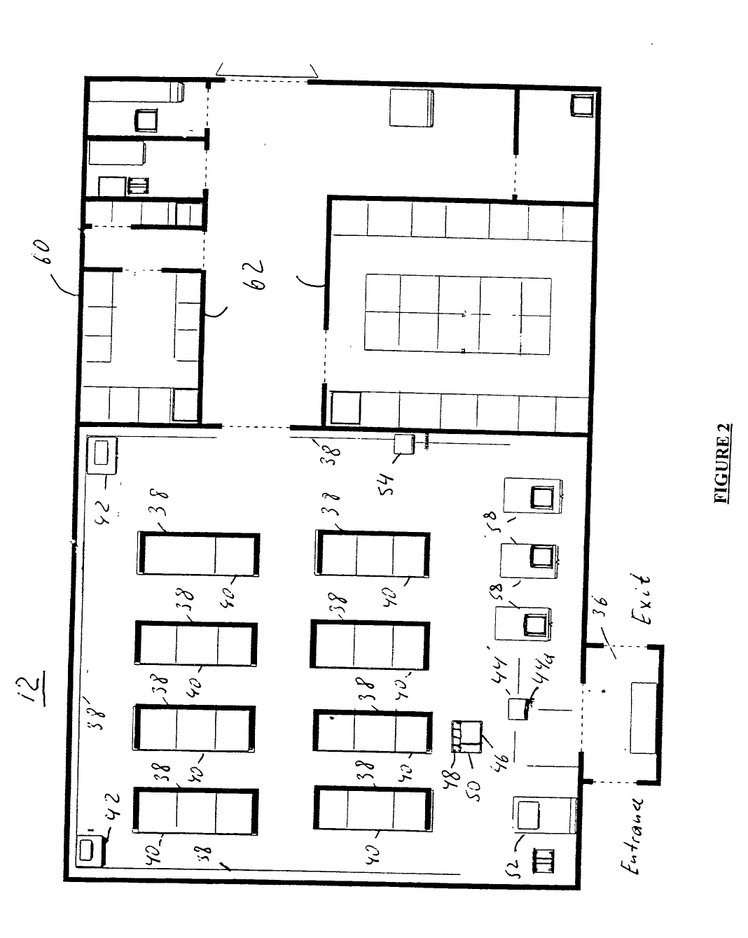

FIG. 2 illustrates an exemplary arrangement of the retail facility 12 of the present invention. In the illustrated example, the retail facility 12 combines purchase ordering and purchase check-out facilities. However, as discussed above, the retail facility 12 may be only a purchase ordering facility or only a purchase check-out facility.

The retail facility 12 comprises an entrance/exit area 36 that provides customer's access to the retail facility 12 and enables the customers to exit the retail facility 12. The entrance/exit area 36 may contain a rack 36a for storing customer's bags while the customer is in the retail facility 12. Multiple showcases, display racks, bins, shelves and the like generally designated by reference number 38 are provided in the retail facility 12 for holding and displaying samples representative of products available for sale. The display elements 38 may be arranged along the walls of the retail facility 12. If the purchase ordering facility is arranged in the same room with the purchase check-out facility, the display elements 38 may be provided around shopping tables 40 used for purchase checkout. The display elements 38 are structured to permit substantially unobstructed customer's access to the samples, which may include actual products, their models, visual representations of products, such as photographs, plaster casts, and the like.

Each sample is provided with a label giving information on a particular product, and having indicia unique to the product represented by the sample. For example, the indicia may be in the form of a bar code. The label may contain the name of the product, its price, and such information as product's weight, size, manufacturer, nutritional value, etc.

In addition, the retail facility 12 may contain purchase ordering terminals 42 that enable customers to order all goods available for sale in the retail system 10 including the products that are not represented by the samples available in the retail facility 12. As discussed in more detail later, the purchase ordering terminal 42 may provide a customer with all capabilities of a regular e-commerce Internet site with a substantially higher data processing rate, and without a security risk due to the transmission of sensitive customer's information over the Internet.

Also, the retail facility 12 may contain an identification and control terminal 44 arranged near the entrance/exit area 36. The identification and control terminal 44 may be used for identifying a customer that intends to place a purchase order. If a purchase ordering facility is provided in the same room as a purchase checkout facility, the terminal 44 may distinguish the purchase ordering customer from a customer that enters the retail facility 12 to check out an earlier ordered purchase. Such identification serves to prevent stealing goods and equipment from the retail facility 12.

The identification and control terminal 44 controls a passing device 44a, such as a turnstile, so as to allow a customer to pass through the passing device 44a only after the customer is identified by the identification and control terminal 44. The identification and control terminal 44 may be provided with a data communications circuit for providing data exchange with the central data base and control system 16.

Entrance/exit ports 46 are arranged near the turnstile 44a to maintain hand-held order forming terminals 48 that may be used by customers for placing a purchase order. The hand-held order forming terminal 48 of the present invention may be any device capable of reading samples' indicia that provide information on goods. For example, the order forming terminals 48 may comprise a central processing unit interacting with a ROM and a RAM, a display, such as an LCD panel, a scanning device, such as a scanning keyboard, a speaker, and a modem for providing wireless data exchange. Also, the hand-held order forming terminals 48 may be provided with an infrared port for providing infrared data exchange. Each hand-held order forming terminal 48 may be identified by unique indicia provided on its surface.

The entrance/exit ports 46 may comprise terminal storage ports having charging devices for charging the hand-held terminals 48, and reading devices for reading the indicia on the terminals 48 to provide identification of the terminals 48. Also, the entrance/exit ports 46 may comprise communications ports for receiving information from the hand-held terminals 48 carried by the customers, and transmitting this information to the central data base and control system 16, and to printers 50 that also may be arranged at the entrance/exit ports 46. Alternatively, the communications ports and printers 50 may be provided on the shopping tables 40. In this case, instead of modems for wireless communications, the terminals 48 may be equipped with connectors connectable with connectors of the communications ports and printers 50. Each printer 50 may be identified by indicia provided on its surface. A manager's terminal 52 may be arranged to perform management and administrative functions.

In accordance with one aspect of the invention, to enable a customer to order a purchase in one retail facility 12 and receive the ordered purchase in another retail facility 12, each retail facility 12 may be provided with a list of the retail facilities 12 in the retail system 10. For example, a graphical terminal 54 may be used for presenting such a list. This list may be displayed in a form of a map showing locations of the retail facilities 12. Each retail facility 12 in the list may be provided with indicia readable by the order forming terminal 48.

To provide the retail facility 12 with purchase check-out capabilities, multiple check-out stations 58 may be arranged near the exit. Also, the retail facility 12 may have a service and supply area 60 including storage sections 62 for storing products ordered by customers. For example, freezing and refrigerating chambers may be provided.

Although FIG. 2 illustrates an example in which a purchase check-out facility is provided in the same room as a purchase ordering facility, one skilled in the art will recognize that a purchase check-out facility and a purchase ordering facility may be arranged in separate rooms of the retail facility 12.

All customers enter the retail facility 12 through the turnstile 44a controlled by the identification and control terminal 44. A purchase ordering button and a purchase check-out button may be provided on the identification and control terminal 44. If a customer has a customer card identifying him or her as a permanent customer of the retail system 10, ID data of the card is read by the identification and control terminal 44 that sends a customer identification signal to the central base and control system 16. Also, the customer may activate the purchase ordering button or the purchase check-out button to indicate whether he or she intends to place a purchase order or check out the ordered purchase. This information in association with the customer's ID information is transmitted to the central base and control system 16. If no customer card is available, the customer activates the purchase ordering button or the purchase check-out button on the identification and control terminal 44 that sends to the central base and control system 16 a purchase ordering signal or a purchase check-out signal associated with data advising the system about a new customer.

When the customer is identified, the identification and control terminal 44 allows the customer to pass through the turnstile 44a and take the hand-held order forming terminal 48 provided on the entrance/exit port 46.

When the terminal 48 is removed from the port 44, the central base and control system 16 automatically receives information identifying the terminal 48 in association with a particular customer to assign a particular order forming terminal 48 to a particular customer. As one customer at a time is allowed to pass through the turnstile 44a and take the order forming terminal 48, each order forming terminal 48 is associated with a particular customer. For example, assignment of the order forming terminals 48 may be made by reading terminal's ID information represented by the indicia on the order forming terminal 48.

The order forming terminal 48 carried by a customer enables the customer to place a purchase order in the retail facility 12. In particular, the customer selects a required item among the samples provided in the retail facility and uses the order forming terminal 48 to read the indicia that represent the selected item. For example, a scanning device, such as a scanning keyboard, may be employed for reading visual indicia, such as bar code.

The order forming terminal 48 may be provided with a sound indicator, such as a speaker, to produce a sound signal confirming that the indicia have been read. Information read by the order forming terminal 48 may be displayed on a terminal's display, such as an LCD panel. For example, the display of the terminal 48 may display the name of the product, its price, and such information as product's weight, size, manufacturer, nutritional value, etc.

To order several items of the same product, a customer may scan the product several times. Alternatively, a quantity button may be provided on the order forming terminal 48 to enable the customer to order required quantity of the selected product.

The products' information read by the customer may be stored in a memory device of the order forming terminal 48 until all required items are selected. Each time a new item is selected, the terminal's display may indicate the price of the entire purchase order consisting of multiple selected items.

The order forming terminal 48 may be provided with scrolling abilities to enable the customer to view the entire purchase on the terminal's display. Also, the order forming terminal 48 may enable the customer to edit a purchase order. For example, a particular selected item may be deleted, or the selected quantity may be changed.

Thus, by contrast with regular shopping facilities, a customer rather than a sales person performs scanning of a selected product. Hence, the shopping process is facilitated because the customer is enabled to modify the purchase without interaction with a sales person.

When, a customer completes selection of required items, he or she may use the graphical terminal 54 presenting a list of the retail facilities 12 in the retail system 10 to select a retail facility 12 for delivery the ordered purchase. For example, the customer may use the order forming terminal 48 to read indicia representing the required retail facility 12 in the list displayed by the graphical terminal 54. The ID information of the retail facility 12, in which the customer intends to pick up the ordered purchase, will be added to the purchase order stored in the memory device of the order forming terminal 48.

If a customer does not use the graphical terminal 54 to choose a particular retail facility 12, ID information representing the retail facility 12, in which a purchase order is placed, may be added to the purchase order to enable the customer to pick up the purchase order in that retail facility.

Also, identification information for a permanent customer of the retail system 10 may include the location at which the customer wishes to pick up the ordered purchase. If the customer does not select another location for picking up an ordered purchase, the purchase will be delivered to the location associated with the identification information of the customer.

When a customer is satisfied with a purchase order, he or she may activate the printer 50 to print out the purchase order. For example, the order forming terminal 48 carried by the customer may read indicia representing a particular printer 50 arranged in the retail facility 12 to activate that printer 50.

In accordance with one aspect of the invention, the activation of the printer 50 by an order forming terminal 48 automatically informs the central data base and control system 16 that the process of placing a purchase order for a particular customer associated with that order forming terminal 48 is completed. Also, the activation of the printer 50 may automatically initiate the transfer of the purchase order from the order forming terminal 48 to the central data base and control system 16. In response to the activation of a particular printer 50, the central data base and control system 16 enables that printer 50 to print out the purchase order.

The printout of the purchase order may contain indicia readable by the identification and control terminal 44. The indicia on the purchase order printout may identify a customer and the order forming terminal 48 assigned to that customer. The terminal 44 may read the indicia on the purchase order printout to allow a customer to leave the retail facility 12. For example, in response to the data read from the purchase order printout of a particular customer, the identification and control terminal 44 may check whether the order forming terminal 48 assigned to that customer is returned to the entrance/exit ports 46. The identification and control terminal 44 controls the turnstile 44a to allow the customer to pass through the turnstile 44a only if he or she returns the order forming terminal 48 to him or her.

Alternatively, the identification and control terminal 44 may be activated by data read from the customer's card to enable a customer to leave the retail facility 12 without placing a purchase order. A sales assistant may assist customers that do not have customer's cards.

In accordance with an aspect of the present invention, the purchase ordering terminals 42 installed in the retail facility 12 enable customers to order all goods available for sale including the items that are not represented by the samples available in the retail facility 12. The purchase ordering terminal 42 may include a personal computer interacting with a high-capacity compact memory device, such as a CD-ROM, DVD, etc. A single high-capacity purchase ordering memory device may be provided for multiple purchase ordering terminals 42 installed in the retail facility 12.

The memory device may contain data on all items available for sale in the retail system 10, and a program that defines an algorithm of purchase ordering using the purchase ordering terminal 42. For example, the purchase ordering algorithm may enable the terminal 42 to display graphical presentation of a supermarket having shelves stocked with specific goods displayed for sale. These goods represent items that may be ordered. A customer is enabled to browse the shelves to select required items. To facilitate selection, the purchase ordering terminal may be provided with a touch-screen monitor that enables customers to make selection by touching required items displayed on the screen.

The purchase ordering terminal 42 may operate in various purchase ordering modes. In addition to the supermarket-simulation mode discussed above, the purchase ordering terminal 42 may present an electronic catalog including goods available for sale in the retail system 10. Also, the purchase ordering terminal 42 may simulate a space flight, various games, such as soccer, football or hockey, or operations of an e-commerce Internet site. A selection circuit may be provided to enable customers to select a desired purchase ordering mode.

The central base and control system 16 periodically updates product data stored in local purchase ordering memory devices of retail facilities 12 to reflect changes in the inventory.

A customer may combine purchase ordering using the hand-held order forming terminal 48 with purchase ordering performed using the purchase ordering terminal 42. In this case, the order forming terminal 48 assigned to a customer may be used to activate the purchase ordering terminal 42. This activation provides the central base and control system 16 information on a particular customer that uses the purchase ordering terminal 42. In response to the activation, the purchase ordering terminal 42 automatically reads from the order forming terminal 48 information on previously selected items. These items may be included in a customer's “shopping cart” created on the screen of the purchase ordering terminal 42.

Using the purchase ordering terminal 42 operating in a selected mode of purchase ordering, the customer may add to the “shopping cart” any item available in the retail system 10 including the items that are not represented by samples in the retail facility 12. The customer is enabled to edit the contents of the shopping card. For example, some previously selected items may be deleted.

Alternatively, if a customer intends to use only the purchase ordering terminal 42 for placing a purchase order, the purchase ordering terminal 42 may be activated by a key unit assigned to the customer when he or she enters the retail facility 12. In response to activation by the key unit, the central base and control system 16 may obtain information on the customer using the terminal 42, and an empty “shopping cart” may be created on the screen of the purchase ordering terminal 42. Using the purchase ordering terminal 42 operating in a selected mode of purchase ordering, the customer may add to the “shopping cart” any item available in the retail system 10.

When selection of items in a purchase order is completed, the purchase ordering terminal 42 may display a list of retail facilities 12 of the retail system 10 to enable a customer to select a retail facility 12 for delivery of the ordered purchase. If no retail facility 12 is selected, the retail facility 12, in which the purchase order is placed, may be designated for delivery of the ordered purchase. Alternatively, the purchase may be delivered to the location associated with the identification information of a permanent customer.

Then, the customer may acknowledge the purchase order by activating a purchase acknowledgement button. In response to the acknowledgement, the purchase order information is transferred to the central data base and control system 16, and a purchase order printout is printed out by a printer of the purchase ordering terminal. The purchase order printout may contain indicia readable by the identification and control terminal 44 to allow the customer to leave the retail facility 12 through the turnstile 44a.

Thus, the present invention provides a retail mechanism that involves ordering products, and picking them up after a time interval sufficient to deliver the purchase from the storage facility 14 to the retail facility 12. As a result, products can be sold at multiple locations without having to stock warehouses full of products at those locations.

As those skilled in the art of data communications will realize, terminals and ports arranged in the retail facility 12 may communicate with each other and with the central data base and control system 16 using various data communications arrangements. For example, the order forming terminals 48, printers 50, purchase ordering terminals 42, identification and control terminal 44, and entrance/exit ports 48 provided within a particular retail facility 12 may be arranged in a local area network (LAN), such as an Ethernet, coupled to the central data base and control system 16 via a telephone or wireless connection. To support LAN operations, the above-listed devices may be provided with LAN modems, such as Ethernet modems.

Those skilled in the art will recognize that the present invention admits of a number of modifications, within the spirit and scope of the inventive concepts. For instance, the retail facility 12 and its terminals, ports and other elements may be implemented in a number of different ways. They may be implemented using specifically engineered chips having logic circuits and other components for performing the functions described above. Alternatively, they may be implemented using general purpose digital signal processors and appropriate programming.

While the foregoing has described what are considered to be preferred embodiments of the invention it is understood that various modifications may be made therein and that the invention may be implemented in various forms and embodiments, and that it may be applied in numerous applications, only some of which have been described herein. It is intended by the following claims to claim all such modifications and variations which fall within the true scope of the invention.

What is claimed is:

1. A retail system comprising:
at least one purchase ordering facility for providing representations of items offered for sale, and
at least one portable device movable by a customer for detecting indicia of said representations to select the items to be included in a purchase order.

2. The system of claim 1, wherein the representation includes samples of the items.

3. The system of claim 2, wherein said portable device is configured to read the indicia of the samples.

4. The system of claim 3, wherein said portable device is configured to display total price of a purchase after reading the indicia of each sample.

5. The system of claim 1, wherein said portable device is configured to enable the customer to edit the purchase order.

6. The system of claim 1, further comprising a purchase ordering terminal for enabling a customer to order products available for sale in the retail system including the items that are not represented in the purchase ordering facility.

7. The system of claim 6, wherein the purchase ordering terminal is configured to enable the customer to continue placing the product order after selecting the items using the portable device.

8. The system of claim 6, wherein the purchase ordering terminal is configured to read purchase order information from the portable device.

9. The system of claim 6, wherein the purchase ordering terminal is configured to present an electronic catalog including the products available for sale in the retail system.

10. The system of claim 6, wherein the purchase ordering terminal is configured to electronically simulate a store containing the products available in the retail system.

11. The system of claim 6, wherein the purchase ordering terminal is configured to electronically simulate a game.

12. The system of claim 6, wherein the purchase ordering terminal is configured to electronically simulate an Internet site.

13. The system of claim 1, further comprising at least one output device for producing an output representing the purchase order.

14. The system of claim 13, wherein the output device is provided with indicia readable by said portable device.

15. The system of claim 14, wherein the purchase order is automatically transferred from the portable readable device to a central station when the portable device reads the indicia of the output device.

16. The system of claim 14, wherein the output representing the purchase order formed by the portable device is automatically produced when the portable device reads the indicia of the output device.

17. The system of claim 14, wherein the output representing the purchase order controls a passing device that allows the customer to leave the purchase ordering facility.

18. The system of claim 13, wherein said output device includes a printer for printing out the purchase order.

19. The system of claim 1, wherein a purchase ordered at said purchase ordering facility may be picked up at a retail facility remote from said purchase ordering facility.

20. The system of claim 19, wherein said portable device enables a customer to select the retail facility, to which the ordered purchase should be delivered.

21. A retail system having multiple purchase ordering facilities for placing purchase orders, at least one of the retail facilities provides representations of a limited number of items offered for sale, said at least one of the retail facilities is provided with at least one purchase ordering terminal for enabling the customer to order all products available in the retail system.

22. The retail system of claim 21, wherein said at least one of the retail facilities is provided with at least one portable device movable by a customer for forming a purchase order based on the representations of the limited number of items offered for sale.

23. The retail system of claim 22, wherein the customer is enabled to combine purchase ordering using the portable device with the purchase ordering using the purchase ordering terminal.

24. The retail system of claim 23, wherein the purchase ordering terminal is configured for reading purchase order information from the portable device.

25. A retail system comprising a plurality of purchase ordering facilities for enabling customers to place purchase orders and a plurality of purchase checkout facilities for enabling the customers to receive ordered purchases, a customer being enabled to receive an ordered purchase at a purchase check-out facility remote with respect to a purchase ordering facility where the purchase was ordered.

26. The system of claim 25, wherein the purchase ordering facilities contain samples of items offered for sale to enable the customer to select required items.

27. A retail system controlled by a control system and comprising:
at least one storage facility for storing goods available for sale in the retail system,
multiple purchase ordering facilities for enabling a customer to order a purchase, and
multiple purchase obtaining points, each purchase obtaining point enabling the customer to obtain the ordered purchase after a time period sufficient to deliver the ordered purchase from the storage facility to the purchase obtaining point.

28. The retail system of claim 27, wherein at least one of the purchase ordering facilities contain samples of a limited number of items offered for sale.

29. The retail system of claim 28, wherein said at least one of the purchase ordering facilities contain at least one purchase ordering terminal for enabling the customer to order products available for sale in the retail system, including the items that are not represented by the samples.

30. A method of selling goods comprising the steps of:
storing goods available for sale in a storage facility,
presenting samples of the goods at a purchase ordering facility to enable a customer to order a purchase, and
enabling the customer to obtain the ordered purchase at a purchase obtaining point after a time period sufficient to deliver the purchase from the storage facility to the purchase obtaining point.

31. The method of claim 30, wherein the purchase ordering facility presents samples of a limited number of items offered for sale.

32. The method of claim 31, further comprising the step of providing a purchase ordering terminal in the purchase ordering facility for enabling the customer to order products available for sale, including the items that are not represented by the samples.
